(19) United States
(12) Patent Application Publication
(10) Pub. No.: US 2009/0046607 A1
(43) Pub. Date: Feb. 19, 2009

(54) AUTOMATIC GAIN CONTROL APPARATUS AND METHOD IN WIRELESS TELECOMMUNICATION SYSTEM BASED ON TIME DIVISION DUPLEX

(75) Inventors: Mun-kyu Lee, Seoul (KR); Chang-Bae Yoon, Gyeonggi-do (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: POSDATA CO., LTD., Seongnam-si (KR)

(21) Appl. No.: 12/162,586

(22) PCT Filed: Jan. 25, 2007
(86) PCT No.: PCT/KR2007/000446

§ 371 Date: Jul. 29, 2008

(30) Foreign Application Priority Data
Jan. 31, 2006 (KR) 10-2006-0009266

(51) Int. Cl. H04L 5/14

(52) U.S. Cl. 370/294

(57) ABSTRACT

Disclosed is an apparatus and a method for controlling automatic gain in a wireless communication system using a Time Division Duplex (TDD) scheme. The apparatus comprises a power detecting unit for detecting a power of a TDD frame signal on a receive path; an Automatic Gain Control (AGC) synchronizing signal generating unit for generating an AGC synchronizing signal enabled or disabled either during a Down Link (DL) frame or during an Up Link (UL) frame of a TDD frame; an automatic gain calculating unit for calculating a gain control value based on the power detected by the power detecting unit either during the DL frame or during the UL frame of the TDD frame in response to the AGC synchronizing signal; and an AGC unit for performing gain control for the TDD frame signal on the receive path on the basis of the calculated gain control value. Hence, as AGC is performed during only an actual receive frame, the optimized demodulation performance can be maintained.

### TECHNICAL FIELD

The present invention relates to an apparatus and a method for controlling automatic gain in a wireless communication system using a Time Division Duplex (TDD) scheme, and more particularly to an apparatus and a method for controlling automatic gain in a wireless communication system using a TDD scheme, which maintains the stable demodulation performance though a transmitter power is varied in communication coverage, by measuring the signal strength on a receive path and controlling the gain of the signal, in the Wireless Broadband Internet (WiBro) using a TDD scheme.

### BACKGROUND ART

The technology of Automatic Gain Control (AGC) on a receive path is one of core technologies dominating the performance of receiving demodulation in a communication system. As illustrated in FIG. 1, a level of signal received by a receiver can be varied by a change of transmitter (particularly, a terminal) power, distance variation between a base station and the terminal, interference of an obstacle, the movement of the terminal, a change of the surrounding environment of the terminal, etc., and the receiver maintains in a certain range the level of an input signal whose signal levels are different from one another through automatic gain control, and improves the demodulation performance. Namely, the automatic gain control corresponds to an essential algorithm in receive sensitivity/the received strength on a receive path of a communication system, and an optimized algorithm can expand coverage of a wireless communication system.

FIG. 2 is a view illustrating the structure of a transceiver in a wireless communication system using a Frequency Division Duplex (FDD) scheme, and explains transmission and receive paths isolated from each other with different frequency bands. To make a detailed description, the existing wireless communication system using the FDD scheme performs full-duplex communications by dividing a frequency, and uses independent paths because the transmission and receive paths are isolated from each other with different frequency bands (transmission and receive frequencies are respectively denoted as f_{T} and f_{R} in FIG. 2). Therefore, the technology of real-time automatic gain control related to the receive path is applied to the transceiver regardless of the transmission path.

However, as illustrated in FIG. 3, in a wireless communication system using the TDD scheme, because transmission and receive paths are the same path that uses the same frequency band (transmission and receive frequencies are denoted as f_{TR} without discrimination in FIG. 3), the technology of automatic gain control used in the existing FDD scheme cannot be applied to the wireless communication system using the TDD scheme, and automatic gain control technology that operates separately from each other by a time division must be applied.

The prior art associated with this includes patent applications entitled “Selectively Activated AGC Signal Measurment Unit” and “Automatic Gain Control for a Time Division Duplex Receiver,” filed in the Korean Industrial Property Office by Interdigital Technology Corporation, and assigned Serial Nos. 10-2003-7013895 and 10-2003-7013864, etc. The above patent application Serial No. 10-2003-7013895 discloses an automatic gain control apparatus and a method for communicating with one another among multiple transmitters and multiple receivers by using a repeated time frame. Herein, the time frame is subdivided into multiple time slots, and each time slot is assigned to a pair of transmitter and receiver. Accordingly, each pair of transmitter and receiver measures the strength of a received signal during only a related time slot, and performs the automatic gain control. Meanwhile, the above patent application Serial No. 10-2003-7013864 discloses a method and a system for controlling automatic gains of TDD, Time Division Multiple Access (TDMA) or Time Division-Code Division Multiple Access (TD-CDMA) receivers. Herein, a preamble of a TDD frame is formed in the format of Binary Phase Shift Keying (BPSK), and the system for controlling the automatic gains performs automatic gain control by detecting a power level of a BPSK symbol of a preamble positioned in a start part.

However, the automatic gain control technologies according to the above-mentioned prior arts operate during only a time slot related to a relevant pair of transmitter/receiver of the total time slot associated with multiple pairs of transmitters/receivers (the patent application Serial No. 10-2003-7013895), or correspond to a scheme of detecting the power level by using the preamble using the BPSK format (the patent application Serial No. 10-2003-7013864). Accordingly, there exists no technology that distinguishes between a Down Link (DL) frame and an Up Link (UL) frame and separately performs automatic gain control during only a receive frame.

### DISCLOSURE OF INVENTION

### Technical Problem

Accordingly, the present invention has been made to solve the above problems occurring in the prior art, and it is an aspect of the present invention to provide an apparatus and a method for controlling automatic gain, which perform automatic gain control during a receive section among a DL frame and an UL frame in a time division recursion in a wireless communication system using a TDD scheme.

It is another aspect of the present invention to provide an apparatus and a method for controlling automatic gain, which optimizes the demodulation performance, for examples, the receive sensitivity, the received strength, etc., of a Radio Access Station (RAS) using a TDD scheme, and can maintain a stable demodulation performance in receive coverage.

Furthermore, it is another aspect of the present invention to provide an apparatus and a method for controlling automatic gain, which optimizes the demodulation performance, for examples, the receive sensitivity, the received strength, etc., of a Portable Subscriber Station (PSS) using a TDD scheme, and can maintain a stable demodulation performance in receive coverage.

### Technical Solution

In accordance with one aspect of the present invention, there is provided an apparatus for controlling automatic gain in a wireless communication system using a Time Division Duplex (TDD) scheme according to an embodiment of the present invention, including: a power detecting unit for detecting a power of a TDD frame signal on a receive path; an Automatic Gain Control (AGC) synchronizing signal generating unit for generating an AGC synchronizing signal synchronized with either a Down Link (DL) frame or an Up Link (UL) frame of the TDD frame; an automatic gain calculating unit for calculating a gain control value based on the detected power during either the DL frame or the UL frame of the TDD frame in response to the AGC synchronizing signal; and an AGC unit for controlling a gain of the TDD frame signal on the receive path by the calculated gain control value.

In accordance with another aspect of the present invention, there is provided a transceiver in a wireless communication system using a Time Division Duplex (TDD) frame signal, according to an embodiment of the present invention, including: a transmitting/receiving unit having a transmission path for transmitting a TDD frame signal and a receive path for receiving a TDD frame signal; and an Automatic Gain Control (AGC) unit for detecting a power of a TDD frame signal on the receive path during an Up Link (UL) frame of the TDD frame, calculating a gain control value on the basis of the value of the detected power, and performing the AGC of the receive path, wherein the TDD frame comprises a Down Link (DL) frame, an UL frame, a first gap that discriminates between the DL frame and the UL frame, and a second gap discriminating between the UL frame and next DL frame following the DL frame.

In accordance with another aspect of the present invention, there is provided a method for controlling automatic gain in a wireless communication system using a Time Division Duplex (TDD) scheme according to an embodiment of the present invention, including the steps of: (a) receiving a TDD frame signal, including a Down Link (DL) frame and an Up Link (UL) frame, from a Portable Subscriber Station (PSS); (b) detecting a power of the TDD frame signal on a receive path; (c) calculating a gain control value based on the value of the detected power during the UL frame of a TDD frame; and (d) controlling a gain of the TDD frame signal on the receive path on the basis of the calculated gain control value.

In accordance with another aspect of the present invention, there is provided a method for controlling automatic gain in a Portable Subscriber Station (PSS) using a Time Division Duplex (TDD) scheme as a method for controlling automatic gain in a transceiver in a wireless communication system using a TDD scheme, according to an embodiment of the present invention, including the steps of: (a) receiving a TDD frame signal including a Down Link (DL) frame and an Up Link (UL) frame from a Radio Access Station (RAS); (b) detecting a power of the TDD frame signal on a receive path; (c) calculating a gain control value based on the detected power during Down Link (DL) frame of the TDD frame; and (d) controlling a gain of the TDD frame signal on the receive path on the basis of the calculated gain control value.

### ADVANTAGEOUS EFFECTS

According to the present invention, in a wireless communication system using a TDD scheme, automatic gain control is performed during only one frame in which actual data is received during the automatic gain control related to a receive path, and is not performed during the other section, so that the demodulation performance on a receive path, including receive sensitivity, the received strength, etc., can be optimized.

Also, according to the present invention, an AGC synchronizing signal can be easily sampled by iteratively mapping a TDD frame synchronizing signal and 1 Packet Per Second (1PPS) signal at regular intervals.

Furthermore, according to the present invention, a detected digital power is used as an input address of a Read Only Memory (ROM) while calculating gain control value for the automatic gain control, and a gain control value can be easily obtained by using a look-up table which stores a previously measured gain control value corresponding to the power. In addition, as the values of a built-in look-up table within the ROM are varied, the gain control values based on the detected power can be easily varied.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a view illustrating a concept of automatic gain control in a receiver of a wireless communication system;

FIG. 2 is a block diagram illustrating the structure of a transceiver in a wireless communication system using an FDD scheme;

FIG. 3 is a block diagram illustrating the structure of a transceiver in a wireless communication system using a TDD scheme;

FIG. 4 is a view illustrating the structure of a frame that can be used in a wireless communication system using a TDD scheme;

FIG. 5 is a block diagram illustrating the structure of an apparatus for controlling automatic gain in a wireless communication system using a TDD scheme according to the present invention;

FIG. 6 is a timing diagram illustrating a process for sampling an AGC synchronizing signal in connection with a frame of a TDD scheme;

FIG. 7 is a block diagram illustrating the structure of a transceiver in a wireless communication system using a TDD scheme according to the present invention; and

FIG. 8 is a flowchart illustrating a method for controlling automatic gain in an RAS using a TDD scheme according to the present invention.

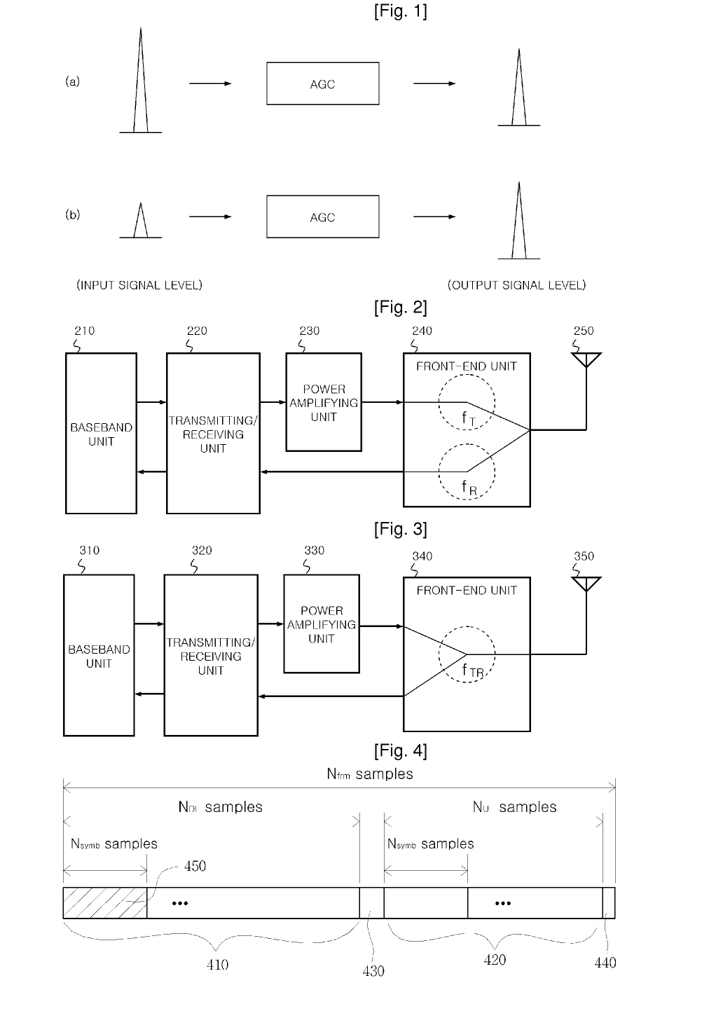

### MODE FOR THE INVENTION

Hereinafter, an exemplary embodiment of the present invention will be described in detail with reference to the accompanying drawings. Well known functions and constructions are not described in detail since they would obscure the invention in unnecessary detail.

For starters, with reference to FIG. 4, the structure of a frame in a wireless communication system using a TDD scheme will be briefly described. The TDD scheme uses one frame which is divided into one sub-frame for transmission and the other sub-frame for reception in a time division transmission scheme. As illustrated in FIG. 4, in the TDD scheme, one frame is divided into a DL frame 410 and an UL frame 420, and full-duplex communications are performed with the same frequency. One frame includes multiple samples, and as illustrated in FIG. 4, one frame consists of N form samples, in which the DL frame 410 is made up of N_{DL} samples, and the UL frame 420 is made up of N_{UL} samples. Also, a Transmission/receive Transition Gap (TTG) (i.e., a first gap) 430 exists between the DL frame 410 and the UL frame 420, and a Receive/Transmission Transition Gap (RTG) (i.e., a second gap) 440 exists in an end part of the frame in order to distinguish between a present UL frame 420 and the next DL frame 410. Meanwhile, in the DL frame 410 and the UL frame 420, N_{symb} samples are gathered to form one symbol, and in this viewpoint, the one frame includes multiple symbols. In a WiBro system, a first symbol 450 of the DL frame corresponds to a preamble, and a specific [PN] random code is modulated in reference to the BPSK on the frequency axis, and a modulated specific [PN] random code is transmitted. This preamble symbol is used for an initial synchronization, a cell search, a frequency offset and the channel estimation, etc.

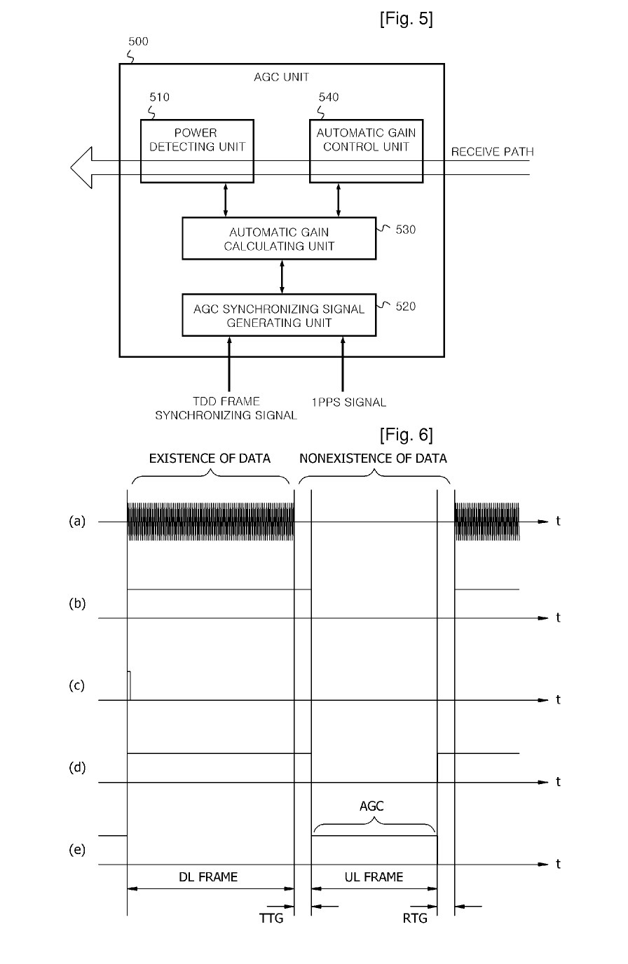

FIG. 5 is a block diagram illustrating the structure of an apparatus for controlling automatic gain in a wireless communication system using a TDD scheme according to the present invention. As illustrated in FIG. 5, the apparatus for controlling the automatic gain (hereinafter, referred to as “automatic gain control apparatus” or “AGC apparatus”) 500 includes an power detecting unit 510, an AGC synchronizing signal generating unit 520, an automatic gain calculating unit 530, and an automatic gain control unit 540.

First, the power detecting unit 510 detects a power of a TDD frame signal received on a receive path. The AGC synchronizing signal generating unit 520 generates an AGC synchronizing signal on the basis of the TDD frame synchronizing signal and 1PPS signal. The AGC synchronizing signal is enabled or disabled during either a DL frame or an UL frame of the TDD frame. Therefore, a receive frame can be correctly discriminated by this AGC synchronizing signal. To add a remark, in a case where the automatic gain control apparatus 500 is installed on a receive path of an RAS, the AGC synchronizing signal will be enabled or disabled during only the UL frame corresponding to the receive frame. On the contrary, in a case where the automatic gain control apparatus 500 is installed on a receive path of a Portable Subscriber Station (PSS), the AGC synchronizing signal will be enabled or disabled during only the DL frame. A detailed process for generating the AGC signal will be mentioned later.

Meanwhile, the automatic gain calculating unit 530 calculates a gain control value based on the power detected by the power detecting unit 510 during either the DL frame or the UL frame of the TDD frame thereof in response to the AGC synchronizing signal. This can also be embodied by enabling the power detecting unit 510 to detect the power during either the DL frame or the UL frame of the TDD frame thereof in response to the AGC synchronizing signal. Furthermore, the automatic gain calculating unit 530 includes a ROM with a built-in Look-Up Table LUT which stores a previously measured gain control value corresponding to the power. In this case, it is desirable that an input address of the ROM uses the power converted into a digital signal, and the ROM outputs a gain control value. Lastly, the automatic gain control unit 540 controls a gain of the TDD frame signal on the receive path on the basis of the gain control value calculated by the automatic gain calculating unit 530.

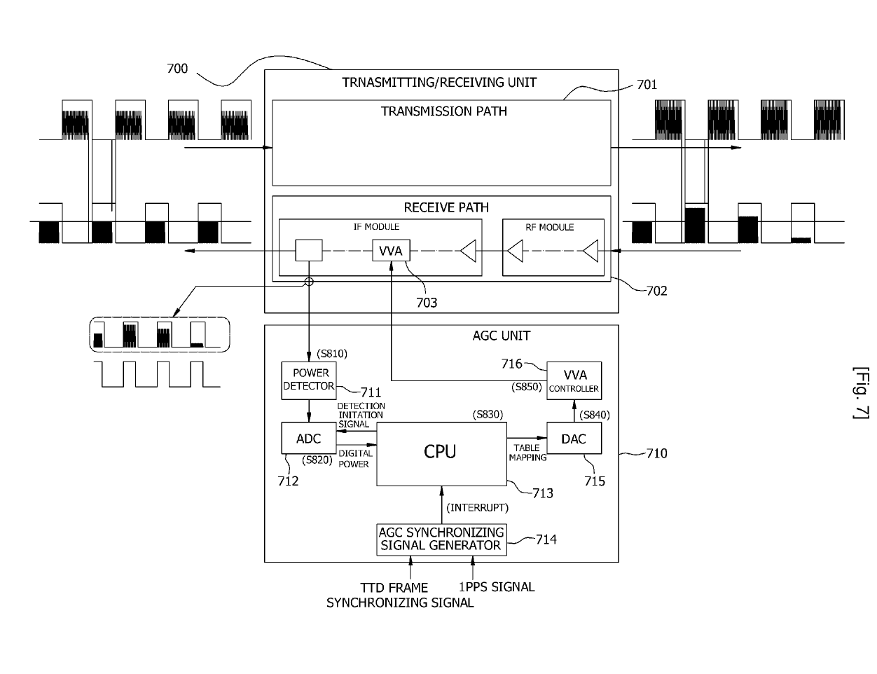

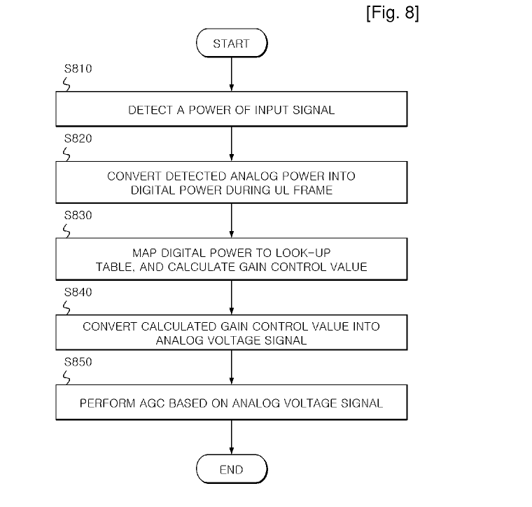

Hereinafter, with reference to FIGS. 6 to 8, in a wireless communication system using the TDD scheme (particularly, a WiBro system), an AGC apparatus and method applied to a receive path of a transceiver will be described together.

In the WiBro system using the TDD scheme, a DL corresponds to a path from an RAS to a PSS, whereas an UL corresponds to a path from the PSS to the RAS. Namely, to look at things from a standpoint of the RAS, the DL corresponds to a transmission path, whereas the UL corresponds to a receive path. Also, the DL and the UL are repeated, and have a cycle that is time-divided. The AGC in the RAS is embodied to operate during only the UL frame corresponding to the receive path among repeated time division cycles, whereas the AGC in the PSS is embodied to operate during only the DL frame corresponding to the receive path. Hence, in order to embody the present invention, a synchronizing signal is necessary which can give notice of the UL frame or the DL frame during which the AGC is performed.

FIG. 6 is a view illustrating a process for sampling a UL frame in a frame of a TDD scheme, i.e., a process for generating an AGC synchronizing signal necessary to perform the AGC in the RAS.

FIG. 6 (a) is a view illustrating a data signal that is actually generated in a baseband unit of the RAS. Data exists during only the DL frame on the time axis denoted by ‘t’, and does not exist during the TTG, during the UL frame, and during the RTG. FIG. 6 (b) is a view illustrating a TDD frame synchronizing signal provided from the baseband unit of the RAS in order to match synchronization with the time when actual data of FIG. 6 (a) is generated. In addition, FIG. 6 (c) is a view illustrating 1PPS signal provided from a synchronizing unit (GPS) of the RAS. The TDD frame synchronizing signal is generated in the baseband unit on the basis of the 1PPS signal. FIG. 6 (d) is a view illustrating the AGC synchronizing signal sampled in order to perform actual AGC in the RAS. The AGC synchronizing signal is sampled while counting through a process for iteratively mapping the TDD frame synchronizing signal and 1PPS signal at predetermined intervals. The AGC synchronizing signal sampled through this process is transmitted to a Central Processing Unit (CPU) on an AGC loop, and is used as a timing diagram for the AGC. FIG. 6 (e) is a view illustrating a signal that inverts the AGC synchronizing signal illustrated in FIG. 6 (d). The (d) and (e) signals illustrated in FIG. 6 can be optionally used according to a configuration of hardware, and because the same function is performed as the (d) and (e) signals are enabled (i.e., ‘ON’ corresponding to a digital logic level ‘1’) or disabled (i.e., ‘OFF’ corresponding to a digital logic level ‘0’) in synchronization with the UL frame, hereinafter, the (d) and (e) signals will be commonly referred to as “AGC synchronizing signal.” In addition, an AGC signal used in a PSS can be generated though a process similar to the process for generating the AGC synchronizing signal in the RAS.

FIG. 7 is a block diagram illustrating the structure of a transceiver in a wireless communication system using a TDD scheme according to the present invention. Even though the transceiver illustrated in FIG. 7 can be applied to both the RAS and the PSS, the following description is made based on the RAS to facilitate a description.

For starters, the transceiver RAS includes a transmitting/receiving unit 700 and an AGC unit 710. The transmitting/receiving unit 700 is equipped with a transmission path 701 and a receive path 702 connecting a baseband unit to an antenna, and performs the origin function of transmission/reception. The AGC unit 710 performs AGC for a TDD frame signal on the receive path in connection with the receive path 702 of the transmitting/receiving unit 700.

The transmitting/receiving unit 700, as stated above, includes the transmission path 701 for transmitting a TDD frame signal generated in the baseband unit to the antenna, and the receive path 702 for transmitting a TDD frame signal received from the antenna to the baseband unit. Meanwhile, so that the transmitting/receiving unit 700 may easily perform AGC related to the received TDD frame signal, the transmitting/receiving unit 700 is desirably equipped with a Voltage Variable Attenuator (VVA) 703 on the receive path. At least one VVA can be embodied in an adequate position on the receive path.

The AGC unit 710 includes a power detector 711, an Analog-to-Digital Converter (ADC) 712, a CPU 713, an AGC synchronizing signal generator 714, a Digital-to-Analog Converter (DAC) 715, and a VVA controller 716, and performs AGC.

To describe the above in detail, first, the power detector 711 couples, at a pre-determined rate, an IF signal (i.e., the TDD frame signal) transmitted from the receive path (i.e., a Radio Frequency (RF) module, an Intermediate Frequency (IF) module, etc.), and detects power (S810). The power detected as an analog signal is converted into a digital signal by ADC 712 (S820), and the converted digital power is transmitted to the CPU 713. In an exemplary embodiment of the present invention, ADC 712 performs an analog-to-digital conversion in response to a detection initiation signal provided from the CPU 713, and transmits the power converted into the digital signal to the CPU 713.

Meanwhile, the AGC synchronizing signal generating unit 714 generates, based on the TDD frame synchronizing signal and the 1PPS signal, an AGC synchronizing signal that gives notice of a section (i.e., an UL frame) during which AGC is performed. A process for generating the AGC synchronizing signal can be grasped by referring to the above-mentioned description with reference to FIG. 6. The AGC synchronizing signal generated in the AGC synchronizing signal generating unit 714 is transmitted to the CPU 713. The CPU 713 generates the detection initiation signal (in the case of the present invention, the AGC synchronizing signal can be directly used as the detection initiation signal) on the basis of the AGC synchronizing signal provided from the AGC synchronizing signal generating unit 714, and uses the AGC synchronizing signal as a synchronizing signal for other AGCs. For instance, the embodiment of the present invention is embodied so that the CPU 713 may control the ADC 712 to convert the analog signal into the digital signal during only the UL frame, but in another scheme, it is possible that another embodiment is accomplished so that the AGC synchronizing signal provided from the CPU 713 or from the AGC synchronizing signal generating unit 714 may directly control the power detector 711 to detect the power of a received signal during only UL frame.

The CPU 713 maps the power transmitted from the ADC 712 to the Look-Up Table LUT, and generates a gain control value (S830). The LUT corresponds to a table which stores a previously measured gain control value corresponding to the power. In this case, it is desirable that a digital power transmitted from the ADC 712 is used as an input address of ROMs. The gain control value calculated in this way is converted into an analog signal in the DAC 715 (S840), and a converted gain control value is transmitted to the VVA controller 716. The VVA controller 716 varies a level of a analog voltage signal (corresponding to the gain control value) to suit VVA control, and performs the function with which the VVA 703 located on the receive path is actually controlled. Finally, the VVA 703 varies a voltage on the basis of a control signal provided from the VVA controller 716, and performs AGC for an input signal (S850). Also, the signal of which the AGC is performed in this manner is detected by the power detector 711, and an AGC loop is formed.

So far, the AGC apparatus and method in the RAS using the TDD scheme have been described, and the AGC apparatus and method are similarly applied even to the PSS using the TDD scheme. Namely, there exists a difference between the case of the PSS using the TDD scheme and the case of the RAS using the TDD scheme, in that the AGC synchronizing signal is enabled (i.e., ‘ON’ corresponding to a digital logic level ‘1’) during only the DL frame, or disabled (i.e., ‘OFF’ corresponding to a digital logic level ‘0’), but the structure or a process in which the AGC is performed is substantially the same as the structure or a process in the case of the RAS. Consequently, since the AGC apparatus and method in the PSS using the TDD scheme can be easily embodied by those skilled in the art with reference to the case of the above-described RAS, a detailed description thereof will be omitted.

Meanwhile, as a result of a measurement of receive sensitivity with reference to the RAS that is actually embodied according to the present invention, receive sensitivity that satisfies the Packet Error Rate (PER) of 0.66 [%] (Packet Errors: 52) of QPSK {½, Convolution Code (CC)} is measured to be less than −90 [dBm] {a standard of Telecommunications Technology Association (TTA) is −86.9 [dBm]}. PER 1.0 [%] (Packet Errors: 83) of 16QAM (½, CC) is measured to be less than −84 [dBm] (a standard of TTA is −81.4 [dBm]).

Thus, it can be recognized that according to the above test (an RAS embodiment), performing AGC during only a frame (i.e., either an DL frame or an UL frame) in which data that is actually transmitted is received rather than performing AGC during all frames and gaps, including DL frames, TTGs, UL frames, and RTGs, of a received TDD frame signal, improves the receive sensitivity.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. An apparatus for controlling automatic gain in a wireless communication system using a Time Division Duplex (TDD) scheme, the apparatus comprising:
a power detecting unit for detecting a power of a TDD frame signal on a receive path;
an Automatic Gain Control (AGC) synchronizing signal generating unit for generating an AGC synchronizing signal synchronized with either a Down Link (DL) frame or an Up Link (UL) frame of the TDD frame;
an automatic gain calculating unit for calculating a gain control value based on the detected power during either the DL frame or the UL frame of the TDD frame in response to the AGC synchronizing signal; and
an AGC unit for controlling a gain of the TDD frame signal on the receive path by the calculated gain control value.

2. The apparatus as claimed in claim 1, wherein the AGC synchronizing signal generating unit generates the AGC synchronizing signal on the basis of a TDD frame synchronizing signal and 1 Packet Per Second (1PPS) signal.

3. The apparatus as claimed in claim 2, wherein the AGC synchronizing signal is generated by iteratively mapping the TDD frame synchronizing signal and the 1PPS signal at predetermined intervals.

4. The apparatus as claimed in claim 1, wherein the automatic gain calculating unit calculates the gain control value by using a look-up table in which a previously measured gain control value corresponding to the detected power is stored.

5. The apparatus as claimed in claim 4, wherein the look-up table is embodied in a Read Only Memory (ROM), an input address of the ROM corresponding to the detected power and an output of the ROM corresponding to the gain control value.

6. The apparatus as claimed in claim 1, wherein the TDD frame comprises a DL frame, an UL frame, and a Transmission/receive Transition Gap (TTG) discriminating between the DL frame and the UL frame.

7. The apparatus as claimed in claim 6, wherein the TDD frame further comprises a Receive/transmission Transition Gap (RTG) discriminating the UL frame and next DL frame following the DL frame.

8. The apparatus as claimed in claim 1, wherein the receive path is a receive path of a Radio Access Station (RAS) receiving a signal transmitted from a Portable Subscriber Station (PSS), and the power detecting unit detects the power during the UL frame.

9. The apparatus as claimed in claim 1, wherein the receive path corresponds to a receive path of the PSS receiving a signal transmitted from the RAS, and the power detecting unit detects the power during the DL frame.

10. A transceiver in a wireless communication system using a Time Division Duplex (TDD) frame signal, the transceiver comprising:
a transmitting/receiving unit having a transmission path for transmitting a TDD frame signal and a receive path for receiving a TDD frame signal; and
an Automatic Gain Control (AGC) unit for detecting a power of a TDD frame signal on the receive path during an Up Link (UL) frame of the TDD frame, calculating a gain control value on the basis of the value of the detected power, and performing the AGC of the receive path,
wherein the TDD frame comprises a Down Link (DL) frame, an UL frame, a first gap that discriminates between the DL frame and the UL frame, and a second gap discriminating between the UL frame and next DL frame following the DL frame.

11. The transceiver as claimed in claim 10, wherein the transmitting/receiving unit comprises a Voltage Variable Attenuator (VVA) for controlling a voltage of the TDD frame signal on the receive path.

12. The transceiver as claimed in claim 11, wherein the AGC unit comprises:
A power detector for detecting the power of the TDD frame signal on the receive path;
an AGC synchronizing signal generator for generating an AGC synchronizing signal synchronized with an UL frame of the TDD frame;
a Central Processing Unit (CPU) for calculating a gain control value on the basis of the detected power during the UL frame of the TDD frame in response to the AGC synchronizing signal; and
a VVA controller for controlling the VVA on the basis of the calculated gain control value.

13. The transceiver as claimed in claim 12, wherein the AGC unit further comprises:
an Analog-to-Digital Converter (ADC) for converting an analog signal of the detected power into a digital signal, and transmitting the converted digital power to the CPU; and
a Digital-to-Analog Converter (DAC) for converting a digital signal of the gain control value provided from the CPU into an analog signal, and transmitting the converted gain control value to the VVA controller.

14. The transceiver as claimed in claim 12, wherein the AGC synchronizing signal generator generates the AGC synchronizing signal on the basis of a TDD frame synchronizing signal and 1 Packet Per Second (1PPS) signal.

15. The transceiver as claimed in claim 14, wherein the AGC synchronizing signal is generated by iteratively mapping the TDD frame synchronizing signal and the 1PPS signal at predetermined intervals.

16. The transceiver as claimed in claim 12, wherein the CPU calculates the gain control value by using a look-up table in which a previously measured gain control value corresponding to the power is stored.

17. The transceiver as claimed in claim 16, wherein the look-up table is embodied in a Read Only Memory (ROM), an input address of the ROM is the power and an output of the ROM is the gain control value.

18. A method for controlling automatic gain in a wireless communication system using a Time Division Duplex (TDD) scheme, the method comprising the steps of:
(a) receiving a TDD frame signal, including a Down Link (DL) frame and an Up Link (UL) frame, from a Portable Subscriber Station (PSS);
(b) detecting a power of the TDD frame signal on a receive path;
(c) calculating a gain control value based on the value of the detected power during the UL frame of a TDD frame; and
(d) controlling a gain of the TDD frame signal on the receive path on the basis of the calculated gain control value.

19. The method as claimed in claim 18, wherein in step (b), the value of power is detected during UL frame of the TDD frame.

20. The method as claimed in claim 18, which further comprises a step of (a′) generating an Automatic Gain Control (AGC) synchronizing signal synchronized with the UL frame on the basis of a TDD frame synchronizing signal and 1 Packet Per Second (1PPS) before step (b), and wherein the UL frame is distinguished by the AGC synchronizing signal.

21. The method as claimed in claim 20, wherein in step (a′), the AGC synchronizing signal is generated by iteratively mapping the TDD frame synchronizing signal and the 1PPS signal at predetermined intervals.

22. The method as claimed in claim 18, wherein in step (c), the gain control value is calculated by using a look-up table which stores a previously measured gain control value corresponding to the detected power.

23. The method as claimed in claim 18, which further comprises a step of (b′) converting an analog value of the detected power into a digital value following step (b).

24. The method as claimed in claim 18, wherein step (d) comprises the steps of:
(d-1) converting the calculated gain control value into an analog value; and
(d-2) controlling the gain of the TDD frame signal on the receive path on the basis of the converted analog value.

25. A method for controlling automatic gain in a Portable Subscriber Station (PSS) using a Time Division Duplex (TDD) scheme as a method for controlling automatic gain in a transceiver in a wireless communication system using a TDD scheme, the method comprising the steps of:
(a) receiving a TDD frame signal including a Down Link (DL) frame and an Up Link (UL) frame from a Radio Access Station (RAS);
(b) detecting a power of the TDD frame signal on a receive path;
(c) calculating a gain control value based on the detected power during Down Link (DL) frame of the TDD frame; and
(d) controlling a gain of the TDD frame signal on the receive path on the basis of the calculated gain control value.

26. The method as claimed in claim 25, wherein in step (b), the power is detected during DL frame of the TDD frame.

27. The method as claimed in claim 25, which further comprises a step of (a′) generating an Automatic Gain Control (AGC) synchronizing signal synchronized with the UL frame on the basis of a TDD frame synchronizing signal and 1 Packet Per Second (1PPS) before step (b), and wherein the DL frame of the TDD frame is distinguished by the AGC synchronizing signal.

28. The method as claimed in claim 27, wherein in step (a′), the AGC synchronizing signal is generated by iteratively mapping the TDD frame synchronizing signal and the 1PPS signal at predetermined intervals.

29. The method as claimed in claim 25, wherein in step (c), the gain control value is calculated by using a look-up table which stores a previously measured gain control value corresponding to the power.
